(19) United States
(12) Patent Application Publication
(10) Pub. No.: US 2009/0117506 A1
(43) Pub. Date: May 7, 2009

(54) Correction Mouthpiece for Ideal Smile

(76) Inventor: Mitsurou Igari, Fukushima (JP)

Correspondence Address: WENDEROTH, LIND & PONACK, L.L.P., 1030 15th Street, N.W.,, Suite 400 East, Washington, DC, 20005-1503, US

(21) Appl. No.: 12/083,010

(22) PCT Filed: Dec. 5, 2005
(86) PCT No.: PCT/JP2005/022710

§ 371 Date: Apr. 3, 2008

(30) Foreign Application Priority Data
Oct. 7, 2005 (JP) 2005-295087

(51) Int. Cl. A61C 7/08

(52) U.S. Cl. 433/6

(57) ABSTRACT

A correction mouthpiece (1) for an ideal smile, by which a shape of an upper labium can be corrected so as to give an ideal smile, includes an upper jaw mouthpiece part (4) having an upper tooth row fitting portion (2) to be fitted to an upper tooth row of a wearer to be corrected and an upper jaw contact portion (3) to be brought into contact with an upper jaw thereof. The upper tooth row fitting portion (2) of the upper jaw mouthpiece part (4) has a front tooth row part fitting portion (2a) having an upper anterior portion integrally provided with an upper labium fitting part (5) to be fitted along the upper labium of the wearer to be corrected. The upper labium fitting part (5) has a concave surface (5a) of a concave surface shape that corrects the upper labium of the wearer to be corrected to have an ideal upper labium shape.

### TECHNICAL FIELD

The present invention relates to a correction mouthpiece for an ideal smile, for correcting a shape of an upper labium so as to give the ideal smile by training mimetic muscles.

### BACKGROUND ART

Conventionally, as a correction tool for correcting a soft smile shape of labia oris, there is suggested a correction tool for a soft smile shape of labia oris, including a stretchable belt-like member having hook members mounted to both ends thereof (see, for example, Japanese Utility Model Application Laid-open No. Hei 03-41613).

The correction tool for a soft smile shape of labia oris is used for correcting the soft smile shape of the labia oris in the following manner. The hook members on both ends of the belt-like member are hooked on both ends of a mouth, respectively. The belt-like member is stretched to run on a back of a head. Accordingly, by a contraction force of the stretchable belt-like member, both ends of the labia oris are pulled upwardly. By repeating this 10 minutes per day, every day for about a week, muscles at both ends of the labia oris are trained. As a result, when a soft smile is given, both ends of the labia oris are each curved upwardly in an arch shape.

However, with the correction tool for a soft smile shape of labia oris of this type, when the soft smile is given, both ends of the labia oris are just curved upwardly in an arch shape to correct the soft smile shape of the labia oris. The correction tool for a soft smile shape of labia oris of this type cannot correct a shape of an upper labium so as to give an ideal smile.

It is an object of the present invention to provide a correction mouthpiece for an ideal smile capable of correcting the shape of the upper labium so as to give the ideal smile.

### DISCLOSURE OF THE INVENTION

According to the present invention, a correction mouthpiece for an ideal smile includes an upper jaw mouthpiece part having an upper tooth row fitting portion to be fitted to an upper tooth row of a wearer to be corrected and an upper jaw contact portion to be brought into contact with an upper jaw thereof, in which: the upper tooth row fitting portion of the upper jaw mouthpiece part has a front tooth row part fitting portion having, in an upper anterior portion integrally provided with an upper labium fitting part to be fitted along an upper labium of the wearer to be corrected; and the upper labium fitting part has a concave surface of a concave surface shape that corrects the upper labium of the wearer to be corrected to have an ideal upper labium shape.

With this structure, the upper anterior portion of the front tooth row part fitting portion in the upper tooth row fitting portion of the upper jaw mouthpiece part is integrally provided with the upper labium fitting part to be fitted along the upper labium of the wearer to be corrected. The shape of the concave surface of the upper labium fitting part is the concave surface shape which corrects the upper labium of the wearer to be corrected to have the ideal upper labium shape. Accordingly, by continuously performing the training with the upper jaw mouthpiece part of the correction mouthpiece for an ideal smile being fitted in the mouth and the upper labium fitting part being fitted to the upper labium, the upper labium is put on the concave surface of the upper labium fitting part to be lifted, thereby correcting the mimetic muscles of portions related to the upper labium. As a result, the upper labium can be corrected to have the ideal upper labium shape of the wearer to be corrected. At the time of training the smile, the correction mouthpiece for an ideal smile is not easily detached, thereby making it possible to stabilize a position of the mouthpiece.

Further, according to the present invention, each of the upper jaw mouthpiece part and the upper labium fitting part is formed of a transparent or translucent resin having shape-retention property and flexibility.

With this structure, since each of the upper jaw mouthpiece part and the upper labium fitting part is formed of a resin having shape-retention property and flexibility, when the wearer to be corrected wears the correction mouthpiece for an ideal smile, while the shape of the correction mouthpiece for an ideal smile is retained, the correction mouthpiece for an ideal smile is gentle for the mouth and causes only little pain. Accordingly, the correction mouthpiece for an ideal smile can be used for a relatively long time for correcting the smile. Further, since each of the upper jaw mouthpiece part and the upper labium fitting part is formed of a transparent or translucent resin, even when the wearer to be corrected wears the correction mouthpiece for an ideal smile, an unnatural look can be avoided.

### BRIEF DESCRIPTION OF THE DRAWINGS

FIG. 1(A) is a front view of an example of an embodiment of a correction mouthpiece for an ideal smile according to the present invention,

FIG. 1(B) is a sectional view taken along the line X-X of FIG. 1(A),

FIG. 2 is a right side view of FIG. 1(A), and

FIG. 3 is a plan view of FIG. 1(A).

### BEST MODE FOR CARRYING OUT THE INVENTION

In order to describe the present invention in more detail, a description is made thereof with reference to the attached drawings.

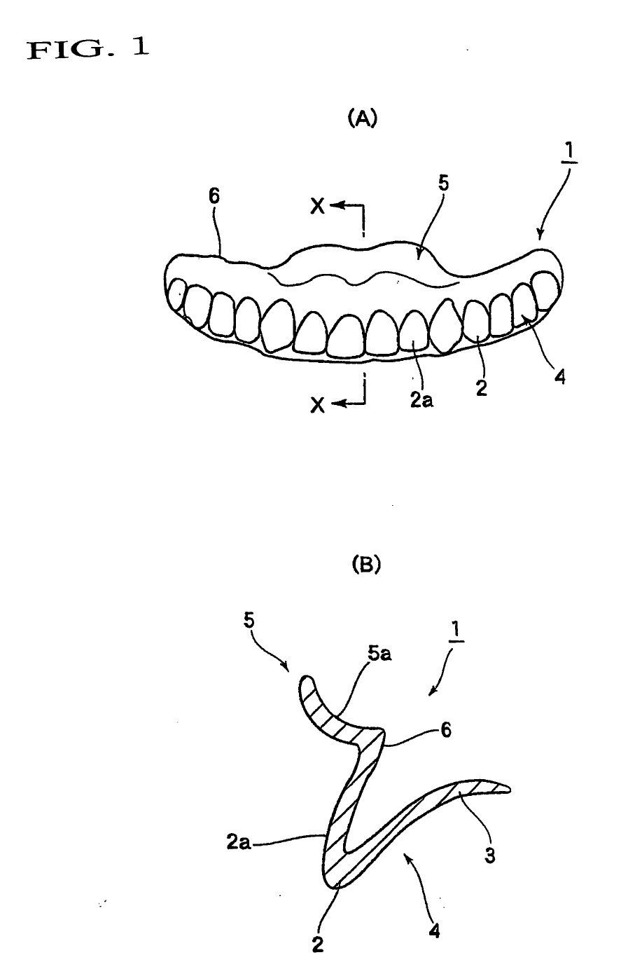

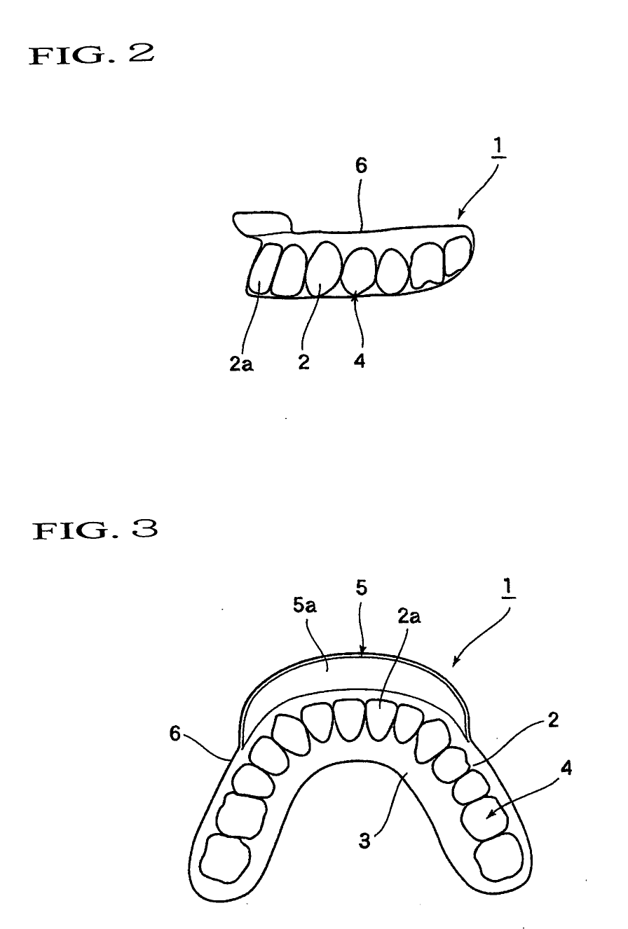

FIGS. 1 to 3 each illustrate an example of an embodiment of a correction mouthpiece for an ideal smile according to the present invention. FIG. 1(A) is a front view of the correction mouthpiece for an ideal smile of this example, FIG. 2(B) is a sectional view taken along the line X-X of FIG. 1(A), FIG. 2 is a right side view of FIG. 1(A), and FIG. 3 is a plan view of FIG. 1(A).

A correction mouthpiece 1 for an ideal smile of this example includes an upper jaw mouthpiece part 4 having an upper tooth row fitting portion 2 to be fitted to an upper tooth row of a wearer to be corrected and an upper jaw contact portion 3 to be brought into contact with an upper jaw thereof. An upper anterior portion of a front tooth row part fitting portion 2a, to be fitted to a front tooth portion of the upper tooth row, of the upper tooth row fitting portion 2 of the upper jaw mouthpiece part 4 is integrally provided with an upper labium fitting part 5 to be fitted along the upper labium of the wearer to be corrected.

The correction mouthpiece 1 for an ideal smile of this example including the upper jaw mouthpiece part 4 and the upper labium fitting part 5 is formed by using a mouthpiece base 6. The mouthpiece base 6 is formed of a thin plate-like material made of a transparent or translucent resin having shape-retention property and flexibility. As the transparent or translucent resin having shape-retention property and flexibility, there is used a resin such as polymethyl methacrylate (PMMA) or polyethylene (PE), or other materials which are safe and have comfort.

The upper tooth row fitting portion 2 of the upper jaw mouthpiece part 4 has, as shown in FIGS. 1 to 3, a front surface of a convex shape corresponding to shapes of the teeth of the upper tooth row. Further, as shown in FIG. 3, the upper tooth row fitting portion 2 has an inner portion of a concave shape which fits to the teeth.

The upper labium fitting part 5 has a concave surface 5a which can fit along the upper labium of the wearer to be corrected. A shape of the concave surface 5a is such a concave surface shape that corrects the upper labium of the wearer to be corrected to an ideal upper labium shape.

The correction mouthpiece 1 for an ideal smile of this example has the front tooth row part fitting portion 2a in the upper tooth row fitting portion 2 of the upper jaw mouthpiece part 4, the front tooth row part fitting portion 2a having the upper anterior portion which is integrally provided with the upper labium fitting part 5 to be fitted along the upper labium of the wearer to be corrected. The shape of the concave surface 5a of the upper labium fitting part 5 is such a concave surface shape that corrects the upper labium of the wearer to be corrected to the ideal upper labium shape. Accordingly, by continuously performing the training with the upper jaw mouthpiece part 4 of the correction mouthpiece 1 for an ideal smile being fitted in the mouth and the upper labium fitting part 5 being fitted to the upper labium, the upper labium is put on the concave surface 5a of the upper labium fitting part 5 to be lifted, thereby correcting the mimetic muscles of portions related to the upper labium. As a result, the upper labium can be corrected to have the ideal upper labium shape of the wearer to be corrected. Regarding the ideal upper labium shape of the wearer to be corrected, when the shape of the concave surface 5a of the upper labium fitting part 5 is formed, with reference to a picture, a poster, or the like of an actor/actress or a celebrity desired, into the upper labium shape in a smiling state of the referential person, the correction can be performed so as to give a smile like that of the favorite actor/actress or celebrity.

Further, the correction mouthpiece 1 for an ideal smile of this example has the upper jaw mouthpiece part 4 to be fitted in the mouth to be chewed. Accordingly, at the time of training the smile, the correction mouthpiece 1 for an ideal smile is not easily detached, thereby making it possible to stabilize a position of the mouthpiece.

Further, since the correction mouthpiece 1 for an ideal smile of this example has the upper jaw mouthpiece part 4 and the upper labium fitting part 5 which are each formed of a resin having shape-retention property and flexibility, when the wearer to be corrected wears the correction mouthpiece 1 for an ideal smile, while the shape of the correction mouthpiece 1 for an ideal smile is retained, the correction mouthpiece 1 for an ideal smile is gentle for the mouth and causes only little pain. Accordingly, the correction mouthpiece 1 for an ideal smile can be used for a relatively long time for correcting the smile.

Further, the correction mouthpiece 1 for an ideal smile of this example has the upper jaw mouthpiece part 4 and the upper labium fitting part 5 which are formed by using the transparent or translucent mouthpiece base 6. Accordingly, at the time of wearing, an unnatural look can be avoided. Further, since the mouthpiece base 6 is formed of a thin plate-like material, an unnatural look in which the mouth is half open at the time of wearing can also be avoided. Even when the correction mouthpiece 1 for an ideal smile is worn, the unnatural look can be avoided, so the correction of the smile can be performed by using the correction mouthpiece 1 for an ideal smile in daily life.

1. A correction mouthpiece for an ideal smile, comprising an upper jaw mouthpiece part having an upper tooth row fitting portion to be fitted to an upper tooth row of a wearer to be corrected and an upper jaw contact portion to be brought into contact with an upper jaw thereof, wherein:
the upper tooth row fitting portion of the upper jaw mouthpiece part has a front tooth row part fitting portion having an upper anterior portion integrally provided with an upper labium fitting part to be fitted along an upper labium of the wearer to be corrected; and
the upper labium fitting part has a concave surface of a concave surface shape that corrects the upper labium of the wearer to be corrected to have an ideal upper labium shape.

2. A correction mouthpiece for an ideal smile according to claim 1, wherein each of the upper jaw mouthpiece part and the upper labium fitting part is formed of a transparent or translucent resin having shape-retention property and flexibility.
